(19) United States
(12) Patent Application Publication
(10) Pub. No.: US 2025/0257220 A1
(43) Pub. Date: Aug. 14, 2025

(54) METHOD FOR PREPARING A COLORED PARTICULATE MATERIAL BY HETEROGENEOUS NUCLEATION

(71) Applicant: UGIEL, PESSAC (FR)

(72) Inventors: Aurélie Annie Eugénie LE BEULZE, Fargues-Saint-Hilaire (FR); Guillaume CROCHET, PESSAC (FR); Etienne DUSSAILLANT, BORDEAUX (FR); Jérôme MAJIMEL, PORTETS (FR)

(21) Appl. No.: 19/047,858

(22) Filed: Feb. 7, 2025

(30) Foreign Application Priority Data
Feb. 13, 2024 (FR) 2401378

(51) Int. Cl. C09C 1/00; C09C 3/06

(52) U.S. Cl. CPC C09C 1/0078; C09C 3/06; C09C 2200/1025; C09C 2200/502; C09C 2220/106

(57) ABSTRACT

The invention relates to a method for preparing colored materials by heterogeneous nucleation of metallic nanoparticles, said nanoparticles exhibiting optical properties based on the surface plasmon phenomenon. The invention also relates to said colored materials obtained, as well as compositions comprising them. In particular, the method for preparing colored particulate material by heterogeneous nucleation notably comprises mixing a suspension at room temperature comprising:
at least one salt of a metallic element, said metallic element exhibiting a plasmonic effect,
at least one reducing agent, and
at least one particulate substrate,
said suspension mixture forming a colored particulate material.

### TECHNICAL FIELD

The present invention relates to the field of coloring materials. The invention relates in particular to a method for preparing colored materials by heterogeneous nucleation of metal nanoparticles, said nanoparticles exhibiting optical properties based on the surface plasmon phenomenon. The invention also relates to colored materials obtained by the method, as well as compositions comprising them.

### PRIOR ART

The use of a metal in the form of nanoparticles can enable a suspension or a solid substrate comprising said nanoparticles to be given a color different from the original color of the solid metal (i.e. a metal not in the form of nanoparticles). Indeed, when a metal nanoparticle is subjected to an electromagnetic field whose wavelength is much greater than its size, the free electrons of the conduction band located on the surface of said nanoparticle are subjected to the same field and oscillate collectively and in phase. When the frequency of the incident wave matches the natural frequency of these oscillations, a resonance phenomenon occurs, called surface plasmon resonance. This resonance can notably take place in the visible, ultraviolet (UV) and infrared ranges. These are then metallic elements exhibiting a plasmonic effect, said metallic elements being in nanometric form.

The plasmon resonance frequency is influenced by various parameters, namely:
the nature of the metal;
the size and the shape of the nanoparticles;
the distribution of the nanoparticles, notably the inter-particle distance; and
the optical properties of the substrate or surrounding medium, notably the refractive index.

In fact, the refractive index modulates color. Said color is perceived differently based on the refractive index. Thus, the color of an object will not be perceived in the same way if the object is present in air or water, for example.

Interestingly, it is possible to modulate these different parameters in order to vary the color of nanoparticles throughout the visible range, or even to shift the resonance frequency to the UV or near infrared region.

To achieve this, it is known to use so-called preformed nanoparticles exhibiting surface plasmon resonance in order to color materials. This technique is very promising and it offers significant advantages with respect to traditional coloring methods. In fact, it can generate a variety of colors, particularly bright colors, without using pigments or dyes that pose a risk to human health and to the environment, which is particularly suitable and useful for certain applications such as tableware, cosmetics, jewelry, watchmaking, food processing or medicine.

However, the use of these preformed nanoparticles has certain drawbacks. By way of example, the production of a material in powder form, i.e. a particulate material, having specific colors requires precise control of the concentration of colloidal suspensions and preformed nanoparticles. Indeed, the size and interactions between preformed nanoparticles within the suspension generate several constraints, such as:
increased viscosity;
reduced stability of the suspension;
difficulties in dispersing the material within the suspension.

For all these reasons, the concentration of preformed nanoparticles in colloidal suspensions needs to be finely controlled and mastered, thus limiting the concentration of preformed nanoparticles in the suspension and indirectly the color intensity of the material, and consequently obtaining a good production yield.

The use of preformed nanoparticles therefore requires the implementation of complex processes comprising numerous steps, using reagents that are often toxic to human health and/or the environment and requiring costly and energy-intensive infrastructures.

For example, patent FR3096685 proposes a new method for preparing a colored micrometric particulate material (i.e. in powder form) from a substrate, using at least one gold salt or at least gold nanoparticles, based on the principle of heterogeneous nucleation.

Heterogeneous nucleation specifically promotes the nucleation and growth of nanoparticles on the surface of a solid substrate, which acts as a catalyst for the reaction. In this way, the solid particulate substrate is colored by the formation of colored nanoparticles on its surface, forming a colored particulate material. This method is particularly advantageous in that it reduces the likelihood of demixing when shaping the material for the final application.

However, the use of the method (FR3096685) has the disadvantage of being limited to certain types of particulate substrates, thus reducing its industrial application potential. As a result, this method cannot be universally adapted and transposed to a wide range of substrates. For example, said method is not suitable for coloring large volumes of particulate substrate. In fact, achieving heterogeneous nucleation catalyzed by heat treatment systematically requires adaptation of the parameters between the method developed on a laboratory scale and the method on an industrial scale so as to maintain the same conditions for the entire volume of particulate substrate. These constraints, on the one hand, increase the development time for new ranges of colored materials and, on the other hand, limit their use to certain types of particulate substrate. Moreover, the need to heat the reaction medium necessarily implies costly and energy-intensive infrastructures.

In addition, growing awareness of climate challenges, coupled with the global objective of reducing greenhouse gas emissions, are encouraging manufacturers to explore alternative methods that are simple, environmentally-friendly, universal and effective for coloring materials.

There is therefore a need for a new method for coloring materials designed to minimize its impact on the environment while maintaining optimum efficiency and adaptability to a wide range of substrates and thus overcoming the drawbacks of the prior art.

### SUMMARY OF THE INVENTION

To meet this need, the invention proposes a new method that overcomes the aforementioned drawbacks, in particular by being suitable for a wide range of substrates, and exhibiting low energy consumption while maintaining optimum coloring efficiency. In particular, the invention provides a new method for preparing a colored particulate material, optionally capable of changing color under the influence of a stimulus, said method is simple, economical, guarantees optimum color stability and has a high degree of modularity, allowing access to a wide range of colors and types of colored materials, and avoiding solvent transfer as far as possible.

In the context of the invention, the substrate is a particulate material, i.e. a material in powder form, on which metal ions forming colored nanoparticles after nucleation will preferentially nucleate and grow, forming a colored particulate material, the latter comprising at least one nanoparticle on its surface, said nanoparticle exhibiting plasmonic properties.

Thus, the invention relates to a method for preparing a colored particulate material by heterogeneous nucleation, comprising the implementation of a single step a) of mixing a suspension at room temperature, said suspension comprising:
at least one salt of a metallic element, said metallic element exhibiting a plasmonic effect,
at least one reducing agent, and
at least one particulate substrate.

According to one variant, the method according to the invention comprises a particulate substrate pre-treatment step, located prior to step a), in order to prepare and condition the particulate substrate to be colored by means of the method according to the invention. This pre-treatment step is preferentially carried out by means of heat treatment and/or alkaline treatment and/or functionalization by means of a coupling agent, thereby activating or adding or modifying surface charges on said substrate.

Such a method makes it possible to form a colored particulate material while overcoming the drawbacks of the prior art. As the method is carried out at room temperature, the method according to the invention advantageously exhibits low energy consumption while exhibiting an acceptable reaction time, thereby reducing operating costs and greenhouse gas emissions compared with an equivalent method of the prior art.

Indeed, the inventors surprisingly discovered that heterogeneous nucleation carried out at room temperature, i.e. at a temperature of between 19 and 25° C., enabled heterogeneous nucleation to be achieved at low energy cost while maintaining optimum coloring efficiency. To achieve this, the inventors have notably identified at least one reducing agent of interest.

Also, according to a preferred embodiment, the reducing agent is selected from the group consisting of sodium tetrahydridoborate (NaBH₄), hydroquinone, tetrabutylammonium borohydride (TBH₄), hydrazine, propanal, glucose, sucrose, citric acid, ascorbic acid, citrate, triethanolamine (TEA), hydroxylamine and mixtures thereof.

In a particularly preferred manner, the reducing agent is triethanolamine (TEA), as it is particularly suitable for heterogeneous nucleation at room temperature, i.e. a reaction that does not need to be catalyzed by heat treatment, while offering an acceptable reaction time. Alternatively, it can also be used at higher temperatures. TEA can thus be used at temperatures ranging from 1° C. to 100° C.

Thus, according to one variant, the invention also relates to a method for preparing a colored particulate material comprising a single step a) of mixing a suspension at a temperature of between 1° C. and 100° C. comprising:
at least one salt of a metallic element, said metallic element exhibiting a plasmonic effect;
triethanolamine (TEA); and
at least one particulate substrate.

The method according to the invention thus enables a varied spectrum of colors to be obtained and is highly modular, thus making it possible to color a wide range of materials with a wide range of colors.

Advantageously, the method according to the invention is suitable for coloring all types of material with all types of salts of metallic elements, said metallic elements exhibiting a plasmonic effect.

According to a particularly advantageous embodiment of the invention, the salt of a metallic element, said metallic element exhibiting a plasmonic effect, is selected from a gold salt, a silver salt, a copper salt, an aluminum salt, a magnesium salt, an indium salt, a nickel salt, a gallium salt, a cobalt salt, an iron salt, a palladium salt, a ruthenium salt, a rhodium salt, a platinum salt and mixtures thereof.

The metallic element salt is a salt wherein the metallic element is in the oxidation state. For example, gold salt (+III) is a salt wherein gold is in the oxidation state (+III).

According to one embodiment, the gold salt (+III) is selected from tetrachloroauric acid HAuCl₄, potassium tetrachloroaurate KAuCl₄ and mixtures thereof, preferably KAuCl₄.

According to one embodiment, the silver salt (+I) is selected from AgNO₃, AgClO₄, Ag(acac), AgCl, Ag₂SO₄ and mixtures thereof, and preferably AgNO₃.

According to one embodiment, the copper salt (+II) is selected from copper chloride (CuCl₂), copper acetate (Cu(CH₃COO)₂), copper sulfate (CuSO₄), Cu(acac)₂, Cu₂O (+I), Cu(OH)₂, Cu(NO₃)₂ and mixtures thereof, preferably CuCl₂.

In the context of the invention, any type of particulate material can be used as a particulate substrate to be colored. Thus, the particulate substrate can be selected from organic materials, inorganic materials and hybrid materials.

The method according to the invention is thus suitable for coloring all types of material, thus offering great diversity in the choice of material to be colored. This makes the method versatile, simple and efficient, whilst having low energy consumption.

When the particulate substrate is an inorganic substrate, said substrate can be selected from all known mineral substances. Preferentially said substrate is selected from the group consisting of silicates, glasses, metal oxides, rare-earth oxides, metals, frits, enamels, glazes, ceramics, absorption pigments and mixtures thereof.

According to another aspect, the invention also relates to a colored particulate material obtained by the method according to any one of the previously described embodiments.

Finally, according to a last aspect, the invention relates to a colored composition comprising at least one colored particulate material according to the invention, and at least one solvent wherein said colored particulate material is dispersed.

### DETAILED DESCRIPTION OF THE INVENTION

### Definitions

For the purpose of the invention, “stabilizing agent” means charged molecules enabling electrostatic stabilization when they are adsorbed on the surface of nanoparticles, or polymers enabling steric repulsions between nanoparticles.

For the purpose of the invention, “structuring agent” means any molecule capable of adsorbing on to the surface of nanoparticles and thus promoting the growth of certain crystalline faces of the nanoparticle, thus enabling the formation of anisotropic particles.

For the purpose of the invention, “heterogeneous nucleation” means the reduction of a metal ion on the surface of a solid substrate, acting as a catalyst for nucleation. This is in contrast to homogeneous nucleation, where nuclei form spontaneously in the reaction medium.

For the purpose of the invention, “particulate substrate” or “particulate material” means a finely divided, powder-like material comprising a set of particles. Said substrate is in powder form, on which the metallic element salts are deposited to form nanoparticles by nucleation. Advantageously, the largest dimension of said particulate substrate is at most 1 mm.

For the purpose of the invention, “largest dimension” of a nanoparticle or of the particulate substrate means the greatest distance separating two points on the outer contour of said nanoparticle or of said particulate substrate.

For the purpose of the invention, “ambient temperature” means a temperature between 19 and 25° C.

For the purpose of the invention, “acceptable reaction time” means a reaction time of no more than 30 minutes, preferentially less than 15 minutes. The reaction is considered complete when the color observed has stabilized.

### Method for Preparing a Colored Particulate Material

The object of the present invention is therefore a method for preparing a colored particulate material by heterogeneous nucleation with low energy consumption, implemented in a single step.

The method according to the invention thus comprises a step a) of mixing a suspension at room temperature, said suspension comprising:
at least one salt of a metallic element, said metallic element exhibiting a plasmonic effect;
at least one reducing agent; and
at least one particulate substrate.

Said one-step method forming a colored particulate material from said particulate substrate. Said colored particulate material comprising at least one nanoparticle formed on the surface of said colored material.

According to an object of the invention, the particulate substrate used in the method according to the invention can be previously colored either natively or by the presence of nanoparticles formed on its surface. Said nanoparticles can be deposited according to the method of the present invention. In addition, the method according to the invention can be repeated several times, and thus comprise several cycles, each cycle resulting in the formation of a colored particulate material. This is particularly advantageous for obtaining a colored particulate material having the desired coloration.

By way of example, a first cycle can be implemented using a gold salt, followed by a second cycle using a silver salt, etc.

The method according to the invention therefore makes it possible to prepare a colored particulate material by heterogeneous nucleation while overcoming the drawbacks of the prior art. Indeed, the method according to the invention exhibits low energy consumption, thus reducing operating costs and greenhouse gas emissions compared with an equivalent method of the prior art, while maintaining similar coloring efficiency. The colorimetric parameters of the colored particulate material are thus similar to those of a colored particulate material obtained by a method of the prior art, notably the method according to FR3096685.

The method according to the invention is simple, insofar as the formation of nanoparticles on the surface of the particulate material is carried out in a single step, at room temperature. Indeed, implementation at room temperature offers numerous advantages, notably better control of the nucleation parameters during heterogeneous nucleation. Conversely, when implemented at higher temperatures, nucleation may be too rapid, necessitating adjustments, for example the addition of a further temperature stabilization step, before the final target temperature is reached. As a result, at room temperature, these constraints are eliminated.

In addition, the method according to the invention is also suitable for coloring materials on both a laboratory and industrial scale, irrespective of the volume of materials to be colored. In this way, the method according to the invention offers improved reproducibility and time savings with respect to the methods disclosed in the prior art. In fact, this method eliminates the influence of temperature on the nucleation and the growth of nanoparticles on the surface of the particulate substrate, thus facilitating its transposition to industrial scales.

According to a particular object of the invention, the suspension of step a) comprises water and/or an organic solvent.

According to a particular object of the invention, the suspension of step a) is an aqueous suspension. Preferentially, said suspension of step a) comprises at least 5% water by mass with respect to the total mass of said suspension, more preferentially at least 10% water by mass with respect to the total mass of the suspension.

According to another object of the invention, the suspension of step a) is an organic suspension. When the suspension of step a) is an organic suspension, said suspension preferentially comprises alcohol such as ethanol.

According to another embodiment of the invention, the suspension of step a) may comprise a mixture of water and organic solvent in a ratio of between 5:95 and 95:5, preferentially between 60:40 and 40:60.

According to a particularly preferred object of the invention, the mixture of step a) is carried out at room temperature, i.e. at a temperature of between 19° C. and 25° C. Thus, heterogeneous nucleation carried out in step a) is performed without heat treatment. In this way, the reaction can be carried out efficiently, regardless of the volume of material to be colored.

Advantageously, the heterogeneous nucleation carried out during step a) does not require heat treatment, drastically reducing the energy consumption required to implement the method.

However, according to a variant of the present invention, when the reducing agent is TEA, the method can be implemented at a temperature of between 1° C. and 100° C. Preferentially, the method is implemented at room temperature. However, it can be implemented at a temperature above 25° C. for certain specific particulate substrates. The solvent is preferentially aqueous but, according to one variant, can be a hydroalcoholic solvent.

Preferably, mixing step a), regardless of the previously described embodiments, is carried out with stirring, preferentially mechanical stirring, notably by means of a paddle mixer or a bar magnet, thus facilitating the heterogeneous nucleation reaction and contact of the metallic element salts with the particulate substrate.

According to another particularly preferred object, the mixture of step a) comprises at least one salt of a metallic element, said metallic element exhibiting a plasmonic effect, said salt is selected from the group consisting of a gold salt, a silver salt, a copper salt, an aluminum salt, a magnesium salt, an indium salt, a nickel salt, a gallium salt, a cobalt salt, an iron salt, a palladium salt, a ruthenium salt, a rhodium salt, a platinum salt and mixtures thereof.

Even more preferentially, the mixture of step a) comprises at least one salt of a metallic element exhibiting a plasmonic effect selected from a gold salt, a silver salt, a copper salt and mixtures thereof.

In the context of the present invention, the metallic element salts are the precursors of nanoparticles which will be formed by heterogeneous nucleation on the particulate substrate or optionally on a colored particulate material according to the method of the invention, in order to obtain a colored particulate material according to the present invention.

According to another particular embodiment, the mixture of step a) comprises at least two distinct metallic element salts, each exhibiting a plasmonic effect. According to one variant of the invention, the mixture of step a) comprises at least two distinct metallic element salts, each being added to said mixture successively and each exhibiting a plasmonic effect. In other words, a first metallic element salt can be added in order to color the particulate substrate and a second metallic element salt can be added in order to color the particulate material colored with the first salt, in order to obtain a colored particulate material comprising at least two distinct colored nanoparticles.

Preferentially, the mixture of step a) comprises at least one gold salt and one silver salt. Said salts can be added successively or simultaneously.

According to another particular embodiment, the mixture of step a) comprises at least three distinct metallic element salts exhibiting a plasmonic effect. When it comprises three distinct salts, the mixture of step a) preferentially comprises at least one gold salt, one silver salt and one copper salt. Said salts can be added successively or simultaneously.

In a particularly advantageous way, the association and the combination of several salts of distinct metallic elements, each exhibiting a plasmonic effect, broadens the range of possible colors. As a result, by extension, to broaden the range of colored particulate material obtained by means of the method according to the invention.

According to one embodiment of the invention, the mixture of step a) preferentially comprises at least one reducing agent selected from the group consisting of sodium tetrahydridoborate (NaBH₄), hydroquinone, tetrabutylammonium borohydride (TBH₄), hydrazine, propanal, triethanolamine (TEA), boranes, organic acids, amines, sugars and mixtures thereof.

More preferentially, the mixture of step a) comprises at least one reducing agent selected from sodium tetrahydridoborate (NaBH₄), hydroquinone, tetrabutylammonium borohydride (TBH₄), hydrazine, propanal, glucose, sucrose, citric acid, ascorbic acid, citrate, triethanolamine (TEA), hydrolamine and mixtures thereof.

When the reducing agent is selected from amines, it is preferentially selected from triethanolamine (TEA) and hydrolamine.

When the mixture of step a) comprises at least one reducing agent selected from sugars, it is preferentially selected from glucose or sucrose.

When the mixture of step a) comprises at least one reducing agent selected from organic acids, it is preferentially selected from ascorbic acid and derivatives thereof and citric acid and derivatives thereof.

According to another embodiment, step a) comprises citrate as a reducing agent.

Preferentially, the mixture of step a) comprises a molar/mass ratio of said reducing agent and particulate substrate of between 10 and 6500 (mole/gram), more preferentially between 50 and 820 (mole/gram). Conversely, a homogeneous nucleation reaction is likely to occur.

Preferentially, the largest dimension of the particulate substrate to be colored is between 10 nm and 1 mm. Indeed, heterogeneous nucleation performed in step a) is particularly effective on such particulate substrates having such sizes. Conversely, nanoparticles cannot deposit on the surface of the substrate. Additionally, if the substrate is greater than 1 mm, it will not be possible to maintain the various elements in suspension with moderate agitation.

The substrate on which the heterogeneous nucleation reaction is to take place, i.e. the particulate substrate to be colored, can take any form, in particular in the form of platelets such as polyhedra or flakes, or in the form of beads. The method according to the invention is therefore universal and can color numerous types of particulate substrate.

The particulate substrate of the mixture of step a) can be an organic or inorganic material or a hybrid.

When the particulate material is inorganic, it is selected from silicates, glasses, metal oxides, rare-earth oxides, metals, frits, glazes, ceramics, absorption pigments and mixtures thereof.

By way of non-limiting example, the mixture of step a) may comprise an inorganic particulate substrate such as silica, quartz, feldspar, limestone, kaolin, metal oxides, aluminate, alumina, zirconium dioxide, non-oxides, ultra-refractory ceramics such as borides, carbides, refractory metal nitrides, silicon- or magnesium-reinforced ceramics, metals such as aluminum, copper, silver, steel and combinations thereof.

Thus, very advantageously, the method according to the invention is suitable for coloring a wide variety of materials.

According to another embodiment, the particulate substrate can be organic, preferentially cellulose.

Advantageously, the method according to the invention is carried out at room temperature, thus enabling organic and/or heat-sensitive materials to be colored, thus offering a versatile alternative method suitable for coloring heat-sensitive materials.

In the context of the present invention, the particulate substrate can be colorless, transparent, semi-transparent, opaque or colored. Indeed, according to a particular object, said substrate can be colored natively or by the method according to the invention. Such an embodiment is particularly useful when it is desired to repeat the method according to the invention. To this end, the method according to the invention then comprises several successive cycles during which the colored material obtained in the first cycle is used as a substrate in the second cycle, and so on.

Also, according to an object of the invention, the particulate material of step a) may comprise particles surface-coated with a layer containing at least one metal oxide or silicon dioxide. Advantageously, said metal oxide or silicon dioxide layer facilitates the attachment of nanoparticles formed on the surface of the particulate material by heterogeneous nucleation.

According to another object, step a) is carried out in less than 30 minutes, more preferentially in less than 15 minutes. Thus, the method according to the invention advantageously exhibits a lower energy consumption than the method of the prior art, while presenting a similar completion time and coloring efficiency.

According to another embodiment of the invention, the mixture of step a) may also comprise at least one stabilizing agent. When the suspension also comprises at least one stabilizing agent, this is selected from citrate, malate, succinate, citric acid, polyvinyl alcohol, polyacrylic acid, poly(ethylene glycol) (PEG), amino derivatives such as diethylamine, sulfur derivatives such as thiols, triphenylphosphine-based ligands, dendrimers, amino surfactants such as cetyltrimethylammonium bromide (CTAB), sodium dodecyl sulfate (SDS), poly-n-vinyl pyrrolidone (PVP), polyelectrolytes, NMP monomers, and mixtures thereof.

According to another embodiment, the mixture of step a) can also comprise at least one structuring agent. This advantageously makes it possible to direct the growth on certain crystalline faces and thus modulate the shape of the nanoparticles formed on the surface of the material. Controlling the shape of nanoparticles is an important parameter as it enables us to exploit the plasmon resonance of metallic elements and thus control the final color of the colored material.

When the mixture of step a) comprises at least one structuring agent, this is preferentially selected from citrate, malate, succinate, polyvinylpyrrolidone (PVP), surfactants and mixtures thereof. More preferentially, the surfactants are selected from cetyltrimethylammonium bromide (CTAB), diethylamine (DEA), ethylenediaminetetraacetic acid (EDTA), and mixtures thereof.

According to another object, the method according to the invention is implemented in a single step, but it can however comprise additional steps, in particular an isolation step. This separates the colored material in solid form from the liquid phase.

Thus, according to one embodiment of the invention, the method according to the invention comprises the implementation of the following steps:
a. mixing a suspension at room temperature comprising:
   at least one salt of a metallic element exhibiting a plasmonic effect;
   at least one reducing agent, and
   at least one particulate substrate,
b. isolating the colored particulate material obtained in step a), said colored particulate material having at least one nanoparticle formed on its surface by heterogeneous nucleation.

Preferentially, step b) of isolating the colored particulate material from step a) comprises the following sub-steps:
i. solid/liquid separation of the mixture from step a), to isolate the colored particulate material from the liquid phase, said liquid phase comprising the free elements in suspension; and
ii. drying to obtain the colored particulate material in dry form.

Preferentially, solid/liquid separation sub-step i) is carried out by means of at least one solid/liquid separation technique selected from filtration, sedimentation, centrifugation, evaporation, freeze-drying and combinations thereof.

When solid/liquid separation sub-step i) is carried out by means of at least two solid/liquid separation techniques, these steps are performed in succession, advantageously reducing the duration of the isolation step.

According to one embodiment, step b) of isolating the colored particulate material may further comprise at least one additional sub-step of washing or rinsing the colored particulate material. Said step is preferentially carried out after separation and before drying.

The washing or rinsing step is preferentially carried out with water and/or using an organic solvent. When the step comprises washing with water and organic solvent, this can be carried out simultaneously or successively.

Thus, according to a particularly preferred embodiment, the method according to the invention comprises the following successive steps:
a. mixing according to any one of the previously described embodiments, and
b. isolating the colored particulate material obtained at the end of step a) from the liquid phase, said step advantageously comprising the following sub-steps:
i. solid/liquid separation of the mixture from step a) so as to isolate the colored particulate material from the liquid phase, and
ii. optionally, a step of washing the isolated particulate material in water and/or organic solvent; and
iii. drying the particulate material and recovering a colored particulate material in dry, powder form.

According to another embodiment of the invention, step b) of isolating the colored particulate material can be repeated several times, preferentially from 1 to 5 times, more preferentially from 1 to 3 times. Each repetition forms a cycle.

Thus, the method preferentially comprises a step a) and an isolation step b), said isolation step comprising the following successive sub-steps:
i. solid/liquid separation of the mixture from step a) so as to isolate the colored particulate material from the liquid phase;
ii. washing the particulate material from the previous step;
iii. solid/liquid separation of the mixture from the previous step; and
iv. drying to obtain the colored particulate material comprising at least one nanoparticle formed on its surface by heterogeneous nucleation.

Successive washing steps can advantageously remove excess organic compounds, for example reducing agents, stabilizing agents and structuring agents present in the suspension, which are likely to cause problems with the final coloring.

Preferentially, drying is carried out in an oven.

According to a particular object of the invention, at least one nanoparticle is formed on the surface of the colored particulate material, said nanoparticle having a largest dimension of between 2 nm and 100 nm.

Advantageously, the nanoparticle formed on the surface of the colored particulate material has a substantially hemispherical shape. The substantially hemispherical shape is the most thermodynamically stable shape, and is therefore preferred for improved color stability. However, according to some embodiments, it is possible to modulate the shape of the nanoparticles formed on the surface of the colored particulate material according to the knowledge of the skilled person.

According to another object of the invention, the particulate substrate may be porous. The use of such porous substrates advantageously increases the surface area accessible and available for depositing the metal element salts forming the nanoparticles by nucleation. In this context, the nanoparticle formed on the surface of the colored particulate material advantageously has a longitudinal shape, such as a rod shape, particularly when the pore size so permits. The use of porous particulate material thus means that the shape of nanoparticles can be modulated to obtain a wider range of colors.

According to another embodiment, the method according to the invention comprises the implementation of the following steps:
a. mixing a suspension at room temperature comprising:
   at least one salt of a metallic element exhibiting a plasmonic effect;
   at least one reducing agent; and
   at least one particulate material, forming the colored particulate material;
b. optional washing of the mixture,
c. adding at least one salt of a metallic element distinct from the mixture from step a) to the mixture of step a) or b);
d. isolating the colored particulate material resulting from the previous step, said colored particulate material presenting at least two distinct nanoparticles formed on its surface by heterogeneous nucleation.

According to another embodiment of the invention, the method according to the invention comprises a particulate substrate pre-treatment step, prior to step a), in order to prepare and condition the particulate substrate to be colored by means of the method according to the invention. This pre-treatment step is carried out by means of heat treatment and/or alkaline treatment, which activates the surface charges of the substrate to improve nucleation of the nanoparticle, as well as the attachment thereof to the substrate. This pre-treatment step is followed by cooling to room temperature then filtration, followed by drying to obtain a powder, said powder comprising a multitude of particulate substrates, suitable for coloring by means of the method according to the invention.

According to another embodiment, the method according to the invention comprises a particulate substrate pre-treatment step, located prior to step a), in order to prepare and condition the particulate substrate to be colored by means of the method according to the invention. This pre-treatment step is carried out by means of a functionalization treatment of said particulate substrate, which makes it possible to add and/or modify surface charges on said substrate, again making it possible to improve nucleation of the nanoparticle, as well as the attachment thereof to the substrate. Such a functionalization step is implemented by means of a coupling agent adapted to the particulate substrate. Advantageously, the coupling agent is selected from organosilanes. For example, when the substrate is a silica, the coupling agent can be a silane with an amine, aldehyde, acrylate, isocyanate, thiol or carboxylic acid function. This pre-treatment step can be carried out at a temperature of between 15 and 85° C., followed by filtration, then drying to obtain a powder, said powder comprising a multitude of particulate substrates, suitable for coloring by means of the method according to the invention.

Activating or adding charges on the surface of the particulate substrate notably promotes electrostatic interactions between the particulate substrate and the nanoparticles during the heterogeneous nucleation of step a), but also increases the grafting rate of metallic element salts having a plasmonic effect on the particulate substrate.

According to another object of the invention, the method according to the invention consists in implementing the following successive steps:
a. Mixing a suspension at room temperature comprising:
   at least one salt of a metallic element, said metallic element exhibiting a plasmonic effect;
   at least one reducing agent; and
   at least one particulate substrate,
b. isolating, and optionally washing, the colored particulate material of step a), said colored particulate material having at least one nanoparticle formed on its surface by heterogeneous nucleation.

According to a further object of the invention, the method can also comprise a further step, after the colored particulate material has been obtained, wherein a stimulus is applied to said colored particulate material. Such a stimulus makes it possible, notably, to modify the color of the colored particulate material.

Preferentially, said stimulus is an external stimulus such as heat treatment, exposure to UV radiation, use of a laser, spontaneous or induced rehydration. This acts on the shape and size of the nanoparticles and the surrounding optical index, and consequently their color, thus modifying the color of the colored particulate material.

### Colored Particulate Material

According to another aspect, the invention relates to a colored particulate material obtained by the method according to any one of the previously described embodiments.

Preferentially, the colored particulate material according to the invention comprises on its surface at least one nanoparticle formed by heterogeneous nucleation, preferentially a multitude of nanoparticles formed by heterogeneous nucleation.

According to another embodiment, the colored particulate material comprises at least one nanoparticle on its surface, said nanoparticle having a spherical, spheroid or anisotropic shape such as rods, cubes, triangles, bipyramids, etc.

According to a particular embodiment, at least one nanoparticle formed on the surface of the colored particulate material according to the invention has a larger dimension of between 2 and 100 nm, preferentially between 10 and 50 nm.

### Colored Composition

Finally, according to a last aspect, the invention relates to a colored composition comprising at least one colored particulate material according to the invention, and at least one solvent wherein said colored particulate material is dispersed.

Preferentially, the solvent is selected from alcohols such as ethanol, esters such as ethyl acetate, or an aqueous solvent.

### EXAMPLES

### Example 1: Coloring Method According to the Invention by Means of Gold Salts

In this example, the inventors colored a particulate substrate with gold nanoparticles.

To achieve this, the inventors implemented the method comprising the following steps:
a. Mixing with stirring a suspension in a 50 mL flask at room temperature, the
   suspension comprising:
   2 g of substrate, namely, glass frit;
   10 mL of distilled water;
   1.037 mL of TEA at a concentration of 50 mM; and
   0.518 mL of KAuCl₄ at a concentration of 10 mM.

The mixing of step a) was carried out until the color of the suspension was stabilized, namely for 15 minutes.
a. isolating the colored particulate material comprising the following sub-steps:
i. Centrifuging the mixture of step a) at 4000 rpm for 3 minutes to isolate the colored particulate material and the liquid phase,
ii. Washing the colored material from the previous step with water,
iii. Centrifuging the mixture from the previous step at 4000 rpm for 3 minutes to isolate the colored particulate material and the liquid phase,
iv. Drying the colored particulate material from the previous step by means of an oven at 80° C., to obtain a colored particulate material comprising at least one nanoparticle formed on its surface by heterogeneous nucleation, in powder form.

The colored particulate material obtained is then heat-treated (800° C.) in order to obtain the final color. Thus, the glass frit (in powder form) comprising the gold nanoparticles formed on its surface is thus melted and then cooled in order to obtain colored enamel by virtue of the colored particulate material (i.e. the glass frit).

The colorimetric parameters are measured using a spectrophotometer, according to the Lab color model. This model, well known to the skilled person, known as Lab, enables colors to be measured and quantified more precisely over a very wide spectrum. Thus, L is the initial for Luminosity and a and b refer to the chromatic components.

The colorimetric parameters of the colored enamel according to Example 1 are as follows:

$${L}^{⋆} = 44.15 ;$$

$$a = 40 \text{.18} ; and$$

$$b = 12.90 .$$

This example shows that the method according to the invention can be used to color particulate material by heterogeneous nucleation at room temperature.

### Example 2: Coloring Method According to the Invention by Means of Gold Salt and Silver Salt

In this example, the inventors colored a particulate substrate with gold nanoparticles, followed by silver nanoparticles. The method is as follows:
a. Mixing with stirring, a suspension in a 50 mL flask at room temperature for 15 minutes, the suspension comprising:
   2 g of substrate, namely glass frit
   10 mL of distilled water;
   1.037 mL of TEA at a concentration of 50 mM; and
   0.518 mL of KAuCl₄ at a concentration of 10 mM.
b. Mixing with stirring a suspension at 80° C. for 15 minutes comprising:
   the colored particulate material having at least one gold nanoparticle, serving as a new substrate;
   0.375 mL of citrate at a concentration of 50 mM;
   0.187 mL of AgNO₃ at a concentration of 10 mM; and
   600 μL of ascorbic acid at a concentration of 50 mM.
c. isolating the colored particulate material obtained, said isolation comprising the following sub-steps:
i. Centrifuging the mixture obtained at 4000 rpm for 3 minutes to isolate the colored particulate material and remove the liquid phase;
ii. Washing the colored particulate material with water;
iii. Centrifuging the mixture from the previous step at 4000 rpm for 3 minutes to isolate the colored particulate material and remove the liquid phase;
iv. Drying the colored particulate material separated from the liquid phase, said colored particulate material comprising at least one gold nanoparticle and at least one silver nanoparticle.

Here again, as in Example 1, a heat treatment step at a temperature of 800° C. transforms the glass frit into colored enamel.

The colorimetric parameters of the enamel are then measured using a spectrophotometer, according to the Lab color model:

$${L}^{⋆} = 29.32 ;$$

$$a = 35 \text{.96} ; and$$

$$b = 20.61$$

### Example 3: Method for Coloring Method a Large Volume with Gold Salts According to the Method of the Invention

This example aims to demonstrate that the method can be implemented with a larger volume, without affecting the coloring efficiency of the method according to the invention.

The method used in this example comprises the implementation of the following steps:
a. Mixing with stirring a suspension in a 500 mL flask at room temperature, for 15 minutes, the suspension comprising:
i. 10 g of substrate, namely glass frit
ii. 100 mL of distilled water;
iii. 5.183 mL of TEA at a concentration of 50 mM; and
iv. 2.592 mL of KAuCl₄ at a concentration of 10 mM.
b. isolating the colored particulate material from the previous step by implementing the following sub-steps:
i. Centrifuging the mixture obtained at 4000 rpm for 3 minutes to isolate the colored particulate material and remove the liquid phase;
ii. Washing the colored material with water;
iii. Centrifuging the mixture from the previous step at 4000 rpm for 3 minutes to isolate the colored particulate material and remove the liquid phase;
iv. Drying the colored particulate material comprising at least one gold nanoparticle formed on its surface by heterogeneous nucleation.

Here again, a heat treatment step is implemented on the colored particulate material in order to obtain the colored enamel.

The colorimetric parameters of colored enamel, according to the Lab model measured with a spectrophotometer, are as follows:

$${L}^{⋆} = 4 0.15 ;$$

$$a = 45.01 ; and$$

$$b = 14.74$$

### Example 4: Method for Coloring a Large Volume with Gold and Silver Salts According to the Method of the Invention

In this example, the inventors colored a particulate substrate with gold nanoparticles, followed by silver nanoparticles in a large volume. The method is as follows:
a. Mixing with stirring a suspension in a 500 mL flask at room temperature for 15 minutes, the suspension comprising:
   10 g of substrate, namely
   100 mL of distilled water;
   5.183 mL of TEA at a concentration of 50 mM; and
   2.592 mL of KAuCl₄ at a concentration of 10 mM
b. Mixing with stirring a suspension at 80° C. for 15 minutes comprising:
   the colored particulate material having at least one gold nanoparticle, serving as a new substrate;
   1.873 mL of citrate at a concentration of 50 mM;
   0.937 mL of AgNO₃ at a concentration of 10 mM; and
   600 μL of ascorbic acid at a concentration of 50 mM.
c. isolating the colored particulate material obtained, said isolation comprising the following sub-steps:
i. Centrifuging the mixture obtained at 4000 rpm for 3 minutes to isolate the colored particulate material and remove the liquid phase;
ii. Washing the colored particulate material with water;
iii. Centrifuging the mixture from the previous step at 4000 rpm for 3 minutes to isolate the colored particulate material and remove the liquid phase;
iv. Drying the colored particulate material separated from the liquid phase, said colored particulate material comprising at least one gold nanoparticle and at least one silver nanoparticle.

Finally, an additional heat treatment step at a temperature of 800° C. enables a substrate to be colored with said colored particulate material.

The colorimetric parameters of colored enamel, according to the Lab model measured with a spectrophotometer, are as follows:

$${L}^{⋆} = 44.94 ;$$

$$a = 42 \text{.58} ; and$$

$$b = 27.53$$

### Example 5-Verifying the Reproducibility of the Method According to the Invention

The aim of this example is to demonstrate that the method according to the invention allows reproducible results to be obtained. To this end, the method described in Example 3 was carried out 4 times, and the colorimetric parameters of the colored material obtained were measured using a spectrophotometer.

The results are shown in Table 1 below:

TABLE 1

| | L* | a | b |
|---|---|---|---|
| Sample 1 | 40.15 | 45.01 | 14.74 |
| Sample 2 | 43.9 | 41.15 | 11.59 |
| Sample 3 | 44.83 | 42.81 | 10.93 |
| Sample 4 | 45.38 | 43.66 | 10.56 |

The results demonstrate that the method according to the invention enables reproducible coloring results to be obtained.

The invention claimed is:

1. A method for preparing a colored particulate material by heterogeneous nucleation, comprising the implementation of a step a) of mixing a suspension at room temperature, said suspension comprising:
at least one salt of a metallic element, said metallic element exhibiting a plasmonic effect,
at least one reducing agent, and
at least one particulate substrate.

2. The method according to claim 1, characterized in that the suspension comprises at least 5% water by mass with respect to the total mass of said suspension.

3. The method according to claim 1, characterized in that the reducing agent is selected from the group consisting of sodium tetrahydridoborate (NaBH4), hydroquinone, tetrabutylammonium borohydride (TBH4), hydrazine, propanal, glucose, sucrose, citric acid, ascorbic acid, citrate, triethanolamine (TEA), hydrolamine and mixtures thereof.

4. The method according to claim 1, characterized in that the salt of a metallic element is selected from the group consisting of a gold salt, a silver salt, a copper salt, an aluminum salt, a magnesium salt, an indium salt, a nickel salt, a gallium salt, a cobalt salt, an iron salt, a palladium salt, aruthenium salt, a rhodium salt, a platinum salt, and mixtures thereof.

5. The method according to claim 1, characterized in that the largest dimension of the particulate substrate is between 10 nm and 1 mm.

6. The method according to claim 1, characterized in that the particulate substrate is selected from an inorganic particulate substrate from the group consisting of silicates, glasses, metal oxides, rare-earth oxides, metals, frits, glazes, ceramics, absorption pigments and mixtures thereof.

7. The method according to claim 1, characterized in that the duration of step a) is at most 30 minutes.

8. The method according to claim 1, characterized in that the method also comprises a step b) of isolating the colored particulate material obtained in step a), said colored particulate material having at least one nanoparticle formed on its surface by heterogeneous nucleation.

9. The method according to claim 8, characterized in that step b) of isolating the colored particulate material successively comprises the following sub-steps:
i. solid/liquid separation of the mixture from step a), in order to isolate the colored particulate material from the liquid phase; and
ii. drying to obtain the colored particulate material in dry form.

10. The method according to claim 9, characterized in that solid/liquid separation is carried out by means of at least one solid/liquid separation technique selected from filtration, sedimentation, centrifugation, evaporation, freeze-drying and combinations thereof.

11. The method according to claim 8, characterized in that step b) comprises an additional sub-step of washing the colored particulate material.

12. The method according to claim 1, characterized in that the largest dimension of the nanoparticle present on the surface of the colored particulate material is between 2 and 100 nm.

13. The method according to claim 1, characterized in that the method comprises a step prior to step a), of pre-treating the particulate substrate by means of heat treatment and/or alkaline treatment and/or functionalization treatment.
